(19) United States
(12) Patent Application Publication
(10) Pub. No.: US 2018/0067235 A1
(43) Pub. Date: Mar. 8, 2018

(54) STRUCTURED ANTIREFLECTION OPTICAL SURFACE HAVING A LONG LIFETIME AND ITS MANUFACTURING METHOD

(71) Applicant: COMMISSARIAT A L'ENERGIE ATOMIQUE ET AUX ENERGIES ALTERNATIVES, PARIS (FR)

(72) Inventors: Emmanuel OLLIER, GRENOBLE (FR); Nicolas DUNOYER, GRENOBLE (FR)

(21) Appl. No.: 15/694,690

(22) Filed: Sep. 1, 2017

(30) Foreign Application Priority Data
Sep. 5, 2016 (FR) 1658238

(51) Int. Cl. G02B 1/118; G02B 1/02; G02B 5/20

(52) U.S. Cl. CPC G02B 1/118; G02B 5/208; G02B 1/02

(57) ABSTRACT

An antireflection optical surface, exhibiting absorption in the domain of the visible and of the near infrared, comprises a substrate made of a material based on silicon carbide SiC and a set of texturing microstructures carpeting an exposure face of the substrate. Each microstructure is formed by a single protuberance produced on and integral with the substrate. The microstructures have the same shape and the same dimensions, and are distributed over the face of the substrate in a two-dimensional periodic pattern; and the shape of each microstructure is smooth and regular with a radius of curvature that varies continuously from the apex of the microstructure to the face of the substrate.

### CROSS-REFERENCE TO RELATED APPLICATIONS

This application claims priority to foreign French patent application No. FR 1658238, filed on Sep. 5, 2016, the disclosure of which is incorporated by reference in its entirety.

### FIELD OF THE INVENTION

The present invention relates to a structured antireflection surface on a material based on silicon carbide SiC.

The present invention in particular relates to an optical surface exhibiting high absorption in the domain of the visible and low emissivity, able to serve as a solar absorber.

The present invention also relates to a solar absorber made of ceramic of the silicon-carbide type, used on a bulk silicon-carbide (SiC) material or as a SiC absorbing layer deposited on the surface of another material, steel for example, for example forming a solar receiver. This is the main application of this invention.

### BACKGROUND

The solar absorbers known to date use silicon carbide that is structured in its volume or structured surfaces in a material that is different from silicon carbide or interferential deposits obtained from materials different from silicon carbide.

A first document by F. Gomez-Garcia, entitled “Thermal and hydrodynamic behaviour of ceramic volumetric absorbers for central receiver solar power plants: A review”, published in Renewable and Sustainable Energy Reviews 57 52016), 648-658, describes a solar absorber made of silicon carbide that is structured in its volume, the structure taking the form of a porosity in which the solar radiation is partially trapped.

A second document, the article by Y. M. Song et al., entitled “Antireflective grassy surface on glass substrates with self masked dry etching”, published in Nanoscale Research Letters 2013, 8:505, describes the principle of a plasma-etching process that generates, via its chemistry, micro-masking, which micro-masking slows the etching of the substrate material in places. A microstructure including relatively high aspect ratios, which decreases the reflectivity of the surface, results. The approach described in this document only relates to glass and is not directly transposable to silicon carbide. The structures produced here by this process are of sizes smaller than that produced in our proposed patent.

A third document, the article by J. Cai et al., entitled “Recent advances in antireflective surfaces based on nanostructure arrays”, published in Royal Society of Chemistry©, Material Horizons 2015, 2, pages 37-53, describes a first process allowing pseudo-periodic structures to be produced, this time on silicon carbide SiC for light-emitting diode (LED) lighting applications. The conical structures obtained by this process are produced by etching through a metal mask obtained by dewetting thin layers. The reflectivity at 6° incidence in the spectral range extending from 390 to 785 nm is decreased from 20.5% to 1.62%. The same article mentions a second process for producing microstructures by plasma etching of a substrate of silicon Si through a mask of beads made of polystyrene. This second process is here limited to the etching of a silicon substrate and does not describe the development of a shape of the microstructures that is particularly resistant to oxidation.

Similarly to the third document, patent application WO 2013/171274 A1, forming a fourth document, describes an etching process employing micro-masking, the micro-masking being achieved by dewetting metals, and describes a microstructured surface produced on substrates of silicon carbide SiC or of gallium nitride GaN in order to obtain an antireflection function. This process for manufacturing microstructured surfaces is carried out by plasma etching through nano-islands of metal of 10 to 380 nm diameter and inter-island spacing. The islands are formed of metals comprising silver, platinum, aluminium and palladium. The base of the cones is smaller than 400 nm. According to a first production process, the nano-islands of gold are formed by annealing, for 3 minutes at 650° C., a gold layer of 3 to 11 nanometre thickness. According to a second production process, the nano-islands are formed by annealing, for 33 minutes at 650° C., a gold layer of 13 to 21 nanometre thickness. The characteristic dimensions of the obtained microstructures are thus of small size, smaller than about 100 nm. Moreover, the use of metal is generally not recommended in the manufacture of semiconductor devices for reasons of contamination and modification of carrier mobility. Furthermore, this metal-dewetting technique is sensitive to the types of materials used for the substrate, to their single-crystal or polycrystalline character, and to the roughness of the surface of the substrate, which would be desirable to avoid.

Similarly to the third document, patent application WO 2015/114519 A1, forming a fifth document, describes a process for structuring molybdenum using plasma etching of a molybdenum substrate through a mask of beads made of silica or polystyrene. The obtained microstructures described are for example of pyramidal shape and possess sharp edges, favouring the wear of the microstructured surface when it is subjected to a corrosive environment. It is sought to improve the performance of the molybdenum absorbers thus obtained, in particular their lifetime when these surfaces are subjected to high temperatures and to an oxidizing environment such as air. Specifically, these surfaces made of molybdenum have a poor temperature withstand in air because of its oxidization.

The technical problem is to provide antireflection optical surfaces for solar absorbers that have both a high capacity to absorb solar radiation and properties that allow this capacity to withstand high temperatures and in an oxidizing medium such as air.

### SUMMARY OF THE INVENTION

To this end, one subject of the invention is an antireflection optical surface, exhibiting absorption in the domain of the visible and of the near infrared, in particular for thermal solar absorbers, said surface being able to operate at high temperatures, and comprising a substrate, made of a thickness of a first material based on silicon carbide SiC, and having a curved or planar exposure face; and an array of texturing microstructures carpeting the face. The antireflection optical surface is characterized in that each microstructure is formed by a single protuberance produced in the first material, said protuberance being placed on and integral with the substrate; and the microstructures have the same shape and the same dimensions, and are distributed over the face of the substrate in a two-dimensional periodic pattern; and the shape of each microstructure is smooth and regular as it has a single apex and a radius of curvature that varies continuously from the apex of the microstructure to the face of the substrate.

According to particular embodiments, the antireflection optical surface comprises one or more of the following features:
the first material based on silicon carbide is polycrystalline or single-crystal silicon carbide SiC; or polycrystalline or single-crystal silicon carbide SiC, enriched with silicon in the form of islands of silicon Si;
the surface of each microstructure has the same given maximum in height h located in a central zone and corresponding to the height of the microstructure and lowers from the apex to an edge B of a base of the microstructure;
the surface of each microstructure includes a portion of the surface of a parabolic, elliptical or spherical cap;
each microstructure has substantially the same given base diameter d larger than or equal to 0.3 μm and smaller than or equal to 5 μm and preferably comprised between 0.5 μm and 2 μm; and the same given maximum height h of each microstructure is larger than or equal to 0.5 times the base diameter d and smaller than or equal to 1.5 times the base diameter d;
the radius of curvature of each microstructure is larger than or equal to 0.1 μm and distributed about a central radius-of-curvature value comprised between 0.25 μm and 1 μm;
the arrangement of the microstructures on the exposure face of the substrate takes the form of a tiling of elementary microstructure networks, the elementary networks having the same unit-cell shape selected from the group consisting of hexagonal unit cells, square unit cells, and triangular unit cells, and being characterized by a packing density of the microstructures with respect to one another.

Another subject of the invention is a solar absorber including an optical surface such as defined above.

Another subject of the invention is a process for manufacturing an antireflection optical surface, in particular for thermal solar absorbers, said surface being able to operate at high temperatures. The manufacturing process comprises a first step consisting in providing a substrate, made of a thickness of a first material based on silicon carbide SiC, and having a planar or curved exposure face. The manufacturing process is characterized in that it furthermore comprises a second step, executed following the first step, consisting in producing an array of texturing microstructures, carpeting the face, each microstructure being formed by a single protuberance produced in the first material, and placed on and integral with the substrate, and the microstructures having the same shape and the same dimensions and being distributed over the face of the substrate in a two-dimensional periodic pattern, and the shape of each microstructure being smooth and regular as it has a single apex and a radius of curvature that varies continuously from the apex to the face.

According to particular embodiments, the process for manufacturing an antireflection optical surface comprises one or more of the following features:
the first step consists either in providing polycrystalline or single-crystal silicon carbide SiC, or in providing polycrystalline or single-crystal silicon carbide SiC, enriched in silicon in the form of islands of silicon Si;
the first step consists either in isostatically compressing a powder of silicon carbide SiC, or in making polycrystalline silicon carbide SiC grow, or in making single-crystal silicon carbide SiC grow, or in infiltrating silicon at high temperature into a porous carbon-containing matrix;
the second step comprises the following steps consisting in: in a third step depositing a compact monolayer of particles made of a second material on the surface of the substrate; and in a fourth step etching, with a dry-etching process, the substrate on the side of the exposure face through gaps existing between the particles, the second material being selected from the group consisting of silica (SiO₂) and polystyrene (PS), or any other material in the form of beads of required size;
the shape and size of the particles are decreased by dry etching, either in a fifth step executed during the fourth step at the same time as the dry etching of the substrate, or in a sixth step interposed between the third step and the fourth step;
the compact film of particles employed in the third step is deposited either with a deposition technique employing a liquid/air interface to order the particles, which technique is selected from the group consisting of the Langmuir-Blodgett technique, the Langmuir-Schaefer technique, the surface-vortex method, the float-transfer technique, and the mobile-dynamic-thin-laminar-flow technique, or with a deposition technique exclusively involving particles in colloidal solution, which technique is selected from the group consisting of electrophoretic deposition, horizontal deposition by evaporation of a film, deposition by evaporation of a bath, deposition by vertical removal of a submerged substrate and horizontal deposition by forced removal of a contact line;
the dry-etching process implemented in the fourth step is a reactive-ion etch using a gaseous mixture of sulfur hexafluoride (SF₆) and dioxygen (O₂) in a ratio of 5/3;
the etch rate Vsub of the substrate material and the etch rate Vpar of the particles; the etch selectivity Sg, which is defined as the ratio of the etch rate of the substrate to the etch rate of the particles; and the etching time are adjusted so as to consume the particles in their entirety and prevent the creation of sharp edges on the surface of the substrate;
the manufacturing process comprises a seventh step of removing the particles, which step is executed after the fourth step.

### BRIEF DESCRIPTION OF THE DRAWINGS

The invention will be better understood on reading the following description of a number of embodiments, which description is given merely by way of example and with reference to the appended drawings, in which

FIG. 1 is a scanning electron micrograph of a first embodiment of an antireflection optical surface, which is microstructured according to the invention, made of polycrystalline silicon carbide SiC, and obtained by plasma etching through a mask of self-organized beads of 1-micron (μm) diameter;

FIG. 2 is a heightwise cross-sectional view passing through the apexes of three adjacent microstructures of the antireflection optical surface of FIG. 1;

FIG. 3 is a scanning electron micrograph of a second embodiment of an antireflection optical surface, which is microstructured according to the invention, made of silicon-enriched polycrystalline silicon carbide SiCSi, and obtained by plasma etching through a mask of self-organized beads of 0.5-micron (μm) diameter;

FIG. 4 is a general flowchart of a process for manufacturing a textured optical surface of FIGS. 1 to 3 according to a first embodiment;

FIG. 5 is a flowchart of a second embodiment of a process for manufacturing the textured surface structure of FIGS. 1 to 3;

FIG. 6 is a view of a principal mechanism of the dry etching implemented in the manufacturing processes of FIGS. 1 to 3;

FIG. 7 is a view of the reflectivity spectra, measured in the infrared and visible domains, for the antireflection optical surface of the second embodiment of FIG. 3;

FIG. 8 is a comparative view of the reflectivity spectra measured in the infrared and visible domains for the antireflection optical surfaces of the first and second embodiments of FIGS. 1 and 3;

FIG. 9 is a micrograph of a surface of silicon carbide SiC, which surface is different from that of the invention, has parasitic microstructures and was obtained by plasma etching in the absence of use of a mask of self-organized beads of silica;

FIG. 10 is a to-scale optical view of a section of an antireflection surface of silicon-enriched carbide SiCSi according to the second embodiment of FIG. 3, obtained after 745 W/m² of solar illumination concentrated with a concentration factor of 1000 into a concentration spot of 10 mm diameter and a temperature increase in this spot to 676° C.;

FIG. 11 is a to-scale optical view, analogous to that of FIG. 7, of a section of a surface of molybdenum Mo, nanostructured according to the process of aforementioned patent application WO 2015/114519 A1, and obtained after 810 W/m² of solar illumination concentrated with a concentration factor of 1000 into a concentration spot of 10 mm diameter and the achievement of a temperature in this spot of 582° C.;

FIG. 12 is a view of the reflectivity spectra of an absorber made of enriched silicon carbide SiCSi the surface of which is structured according to the second embodiment of FIG. 3, the spectra being measured before and after exposure to incident solar radiation of 900 W/m² of solar radiation concentrated by a Fresnel lens of 1000× magnification and of 33×33 cm² size;

FIG. 13 is a view of the reflectivity spectra in the domains of the visible and of the infrared of an absorber made of enriched silicon carbide SiCSi the surface of which is structured according to the second embodiment of FIG. 3, the spectra being measured at various times during ageing in air at a temperature of 1000° C.;

FIG. 14 is a view of the variation in the solar absorption of a solar absorber made of enriched silicon carbide SiCSi, the exposure surface of the absorber being structured according to the second embodiment of FIG. 3 and exposed to air at a temperature of 1000° C.;

FIG. 15 is a view of the variation as a function of time in the solar absorption of two samples of a solar absorber made of silicon carbide SiC, manufactured using the same manufacturing process, the exposure surface of the absorber being structured according to the first embodiment of FIG. 1 and exposed to air at various temperatures;

FIG. 16 is a scanning electron micrograph of the technical effect of the irregular or uneven shape and the small size of the parasitic microstructures of FIG. 9 on the ageing performance of the microstructured surface in terms of modifications of the shape and size of the microstructures, the ageing in air being viewed after 250 hours at an uninterrupted temperature of 1000° C.; and

FIG. 17 is a scanning electron micrograph of the technical effect of the regular shape and size of the microstructures of a surface according to the invention of FIGS. 1 and 3 on the ageing performance of the microstructured surface in terms of modifications of the shape and size of the microstructures, the ageing in air being viewed after 250 hours at an uninterrupted temperature of 1000° C.

### DETAILED DESCRIPTION

The invention relates to the geometry of structures given to materials based on silicon carbide and to processes for obtaining same, which allow, in a preset wavelength range, the absorption of solar radiation to be increased and, at the same time, a solution that is extremely resistant, in terms of a high stability of the shapes and dimensions of the microstructures, to high temperatures and corrosive media, for example an oxidizing medium such as air, to be obtained.

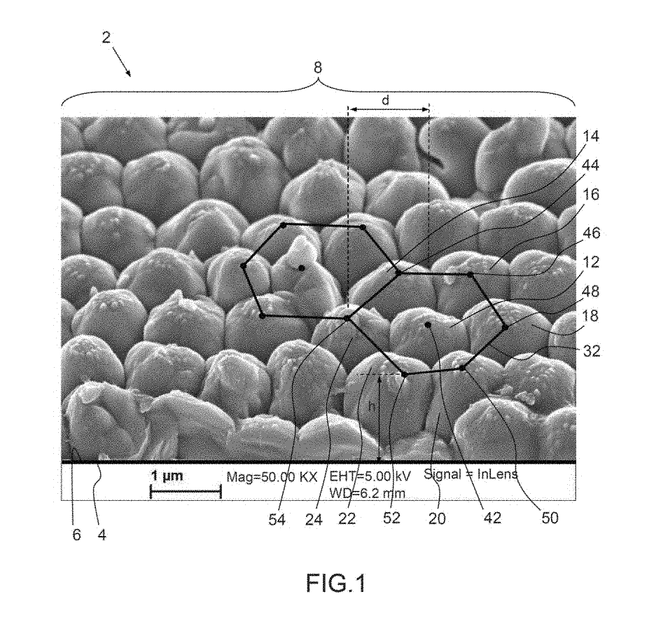

In FIG. 1, an antireflection optical surface 2, exhibiting absorption in the domain of the visible and of the near infrared, in particular for thermal solar absorbers, which surface is able to operate at high temperatures, comprises a substrate 4, made of a thickness e of a first material based on silicon carbide SiC of first type, i.e. of polycrystalline silicon carbide SiC, and having a planar or curved face 6 for exposure to light, sunlight for example.

The antireflection optical surface 2 also comprises a set or an array 8 of texturing microstructures 12, 14, 16, 18, 20, 22, 24 carpeting the exposure face 6 of the substrate.

Here, only seven texturing microstructures 12, 14, 16, 18, 20, 22, 24 have been designated by a reference number for the sake of simplicity of the description.

Each texturing microstructure 12, 14, 16, 18, 20, 22, 24 is formed by a single protuberance produced in the first material, and placed on and integral with the substrate 4.

The microstructures 12, 14, 16, 18, 20, 22, 24 have the same shape, excepting local variations in materials or processes, and the same dimensions; they extend parallelly at least locally with respect to one another in a local direction that is perpendicular to the, here solar, exposure face 6, in the location of each microstructure 12, 14, 16, 18, 20, 22, 24.

The microstructures 12, 14, 16, 18, 20, 22, 24 are distributed over the solar exposure face 6 of the substrate 4 in a two-dimensional periodic pattern 32. Here, the shape of the two-dimensional periodic pattern 32 is for example a hexagonal close-packed shape.

The shape of each microstructure 12, 14, 16, 18, 20, 22, 24 is smooth and regular as it has a single apex 42, 44, 46, 48, 50, 52, 54 and a radius of curvature that varies continuously from the apex of the microstructure 12, 14, 16, 18, 20, 22, 24 to the exposure face 6 of the substrate 4.

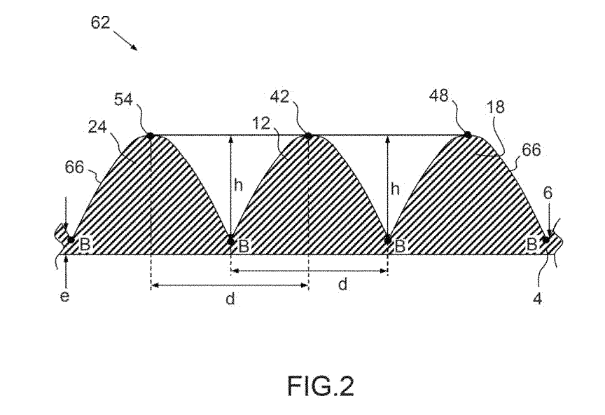

In FIG. 2, a partial cross-sectional profile 62 of the array 8 of microstructures, here the three microstructures 24, 12, 18, which are aligned and adjacent to one another, and of the carrier substrate 4, includes a continuous outline 66 of the exposure surface 6.

In FIGS. 1 and 2, the surface of each microstructure 12, 14, 16, 18, 20, 22, 24 has the same given maximum in height h (which maximum is located in a central zone surrounding its apex and corresponds to the height of the microstructure 12, 14, 16, 18, 20, 22, 24) and lowers from the apex to an edge B of a base of the microstructure 12, 14, 16, 18, 20, 22, 24.

The texturing microstructures 12, 14, 16, 18, 20, 22, 24 are in this example obtained by plasma etching through a mask of self-organized beads having a diameter equal to one micron. The diameter d of a microstructure respectively located below each bead is here, correlatively, about 1 micron, and the height of the shape of each microstructure 12, 14, 16, 18, 20, 22, 24 may here be described by a semi-sphere or a rounded cone or the top part of a parabola.

Here, preferably, all the adjacent microstructures are contiguous at their edges level with the exposure face, and their junction area contains a point or a line of discontinuous curvature.

As a variant, the adjacent microstructures are not contiguous at their edges level with the exposure face, and the junction curve between each microstructure and the exposure face contains a line of discontinuous curvature.

As a variant, the adjacent microstructures are not contiguous at their edges level with the exposure face, and in the vicinity of the junction curve between each microstructure and the exposure face, the curvature is continuous.

Diameters of 0.5 micron may be used and produce an optical performance analogous to that obtained with a diameter of 1 micron. The arrangement of the microstructures 12, 14, 16, 18, 20, 22, 24 in the local plane of the structured surface is periodic, similarly to the arrangement of the carpet of beads used, the periodic pattern of the arrangement preferably being a hexagonal close-packed arrangement, though it could be different.

In FIG. 1, which is a perspective top view of the selective antireflection optical surface 2, it may be clearly seen that the two-dimensional periodic pattern 32 is hexagonal close-packed and that the network of microstructures thus formed is a compact network of hexagonal unit cell.

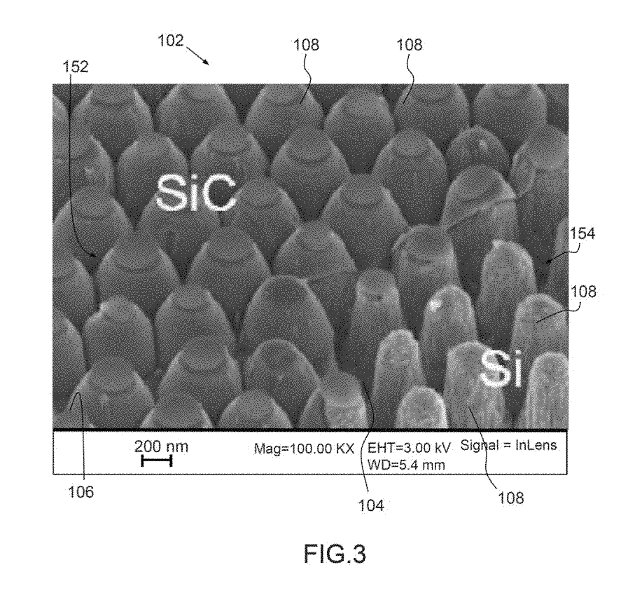

In FIG. 3 and according to a second embodiment of the invention, an antireflection optical surface 102 is structured and produced this time in a material based on silicon carbide SiC of second type (SiSiC), which, similarly to the antireflection surface of FIG. 2, includes silicon carbide SiC, but which is enriched in silicon Si in islands of silicon Si. This second type of material SiSiC is for example obtained by forming a porous carbon-containing material using pyrolysis then infiltrating a silicon precursor at high temperature in order to form the silicon-carbide compound SiSiC. In the case of this second type of material, the obtained structure is analogous to that obtained for the silicon carbide SiC of the material of first type of FIG. 1 and results in a hexagonal close-packed arrangement of structures that may be described by a rounded-cone or parabolic-cap or even semi-sphere shape, the diameter of which is here 0.5 microns.

Here, in FIG. 3, two zones of the material of the substrate 104 and of the microstructures 108 resting on the exposure face 106 of the substrate 104 are partially shown. A first zone 152 made of silicon carbide SiC is illustrated in the upper left-hand corner of FIG. 3 and a second zone 154 made of silicon Si is illustrated in the lower right-hand corner of FIG. 3, which second zone 154 forms an island of silicon Si of the substrate 104.

It will be noted that the residues of silicon beads visible on the top of certain microstructures 108 do not form part of said microstructures and that these bead residues will have disappeared at the end of the manufacturing process because of their consumption by the etching process.

Generally, an antireflection optical surface according to the invention, exhibiting absorption in the domain of the visible and of the near infrared, in particular for thermal solar absorbers, which surface is able to operate at high temperatures, comprises a substrate, made of a thickness of a first material based on silicon carbide SiC, and having a planar or curved exposure face, and an array of texturing microstructures carpeting the exposure face.

Each microstructure is formed by a single protuberance produced in the first material, which protuberance is placed on and integral with the substrate. The microstructures have the same shape and the same dimensions, and are distributed over the face of the substrate in a two-dimensional periodic pattern, and the shape of each microstructure is smooth and regular as it has a single apex and a radius of curvature that varies continuously from the apex of the microstructure to the face of the substrate.

The first material based on silicon carbide is selected from the group consisting of single-crystal silicon carbide SiC, polycrystalline silicon carbide, and polycrystalline or single-crystal silicon carbide SiC enriched with silicon in the form of islands of silicon Si.

Particularly, the surface of each microstructure includes a portion of the surface of a parabolic or elliptical or spherical cap.

Generally and independently of the embodiment of the selective antireflection optical surface, each microstructure has substantially the same given base diameter d larger than or equal to 0.3 μm and smaller than or equal to 5 μm and preferably comprised between 0.5 μm and 2 μm, and the same given maximum height h of each microstructure is larger than or equal to 0.5 times the base diameter d and smaller than or equal to 5 times the base diameter d.

The radius of curvature p of each microstructure is larger than or equal to 0.1 μm and distributed about a central radius-of-curvature value ρ₀ comprised between 0.25 μm and 1 μm.

Generally, the microstructures are arranged on the exposure face of the substrate in the form of a tiling of elementary networks of microstructures, the elementary networks having the same unit-cell shape selected from the group consisting of hexagonal unit cells, square unit cells, and triangular unit cells, and being characterized by a degree of compactness or a packing density of the microstructures with respect to one another.

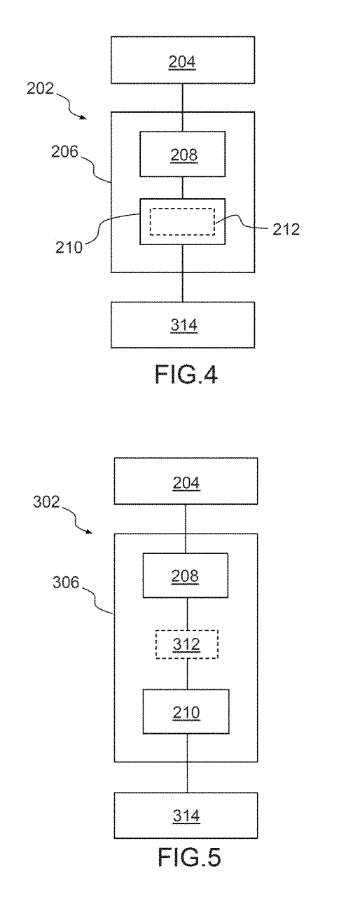

In FIG. 4, and according to a first embodiment, a process 202 for manufacturing the texture of the antireflection optical surfaces such as for example described in FIGS. 1 to 3 comprises a set of steps 204, 206, 208, 210, 212.

This process is in particular suitable for manufacturing thermal solar absorbers, the manufactured textured surface being able to operate at high temperatures and/or in an oxidizing environment such as for example air.

In a first step 204, a thermally stable substrate is provided, consisting of a thickness of a first material based on silicon carbide SiC and having a planar or curved exposure face.

In a second step 206, executed following the first step 204, an array of texturing microstructures carpeting the face of the substrate is produced.

Each microstructure is formed by a single protuberance produced in the first material, and placed on and integral with the substrate.

The microstructures have the same shape and the same dimensions, and are distributed over the exposure face of the substrate in a two-dimensional periodic pattern.

The shape of each microstructure is smooth and regular as it has a single apex and a radius of curvature that varies continuously from the apex of the microstructure to the face of the substrate.

The first step 204 consists:
either in providing polycrystalline or single-crystal silicon carbide SiC, or
in providing polycrystalline or single-crystal silicon carbide SiC enriched in silicon in the form of islands of silicon Si.

Particularly, the first step 204 consists:
either in isostatically compressing a powder of silicon carbide SiC, or
in making polycrystalline silicon carbide SiC grow, or
in making single-crystal silicon carbide SiC grow, or
in infiltrating silicon at high temperature into a porous carbon-containing matrix.

The second step 206 comprises a third step 208 and a fourth step 210, which steps are executed in succession.

In the third step 208, a compact monolayer of masking particles made of a second material is deposited on the surface of the substrate, the second material being selected from the group consisting of silica (SiO₂) and polystyrene (PS), or any other material in the form of beads of required size.

In the fourth step 210, the substrate is etched with a dry-etching process on the side of the exposure face through gaps between the particles.

During the fourth step 210, i.e. at the same time as the dry etching of the substrate, in a fifth step 212, a decrease in the size and shape of the particles is achieved by dry etching.

In FIG. 5 and according to a second embodiment that is a derivative of the first embodiment, a process 302 for manufacturing an antireflection optical surface, which is for example textured for thermal solar absorbers and such as described for example in FIGS. 1 to 3, comprises a set of steps 204, 306, 208, 210, 312.

The first step 204 of the process 302 of FIG. 5 is identical to the first step of the process 202 of FIG. 4.

The second step 306 of the process 302 of FIG. 5 comprises, similarly to the process 202 of FIG. 4, the third step 208 and the fourth step 210.

The second step 306 of the process 302 of FIG. 5 differs from the process 202 of FIG. 4 in that it comprises a sixth step 312, interposed between the third step 208 and the fourth step 210, in which step a decrease in the shape and size of the particles by dry etching is implemented without interaction with the dry etching of the substrate.

In FIGS. 4 and 5, the manufacturing processes 202, 302 comprise a seventh step 314 of removing the particles, which step is executed after the fourth step 210. For example, the seventh step 314 consists in cleaning the textured surface by submerging it in an ultrasonic ethanol bath for at least 5 minutes.

In FIGS. 4 and 5, the deposition of the compact film of particles implemented in the third step 208 is carried out either with a deposition technique of a first family employing an air/liquid interface to order the particles, or with a deposition technique of a second family exclusively involving particles in colloidal solution.

The first family of techniques for depositing particles in a compact film is the group consisting of the Langmuir-Blodgett technique, the Langmuir-Schaefer technique, the surface-vortex method, the float-transfer technique, the mobile-dynamic-thin-laminar-flow technique, and the method for transferring a monofilm of particles compacted on a moving carrier liquid.

The second family of techniques for depositing particles in a compact film is the group consisting of electrophoretic deposition, horizontal deposition by evaporation of a film, deposition by evaporation of a bath, deposition by vertical removal of a submerged substrate and horizontal deposition by forced removal of a contact line.

The deposited masking beads are preferably made of SiO₂, but may be of different nature provided that the principal parameters of the etch are respected.

The parameters supplied to produce the deposits of beads when the method used is the method for transferring a monofilm of particles compacted on a moving carrier liquid and when a textured surface of FIGS. 1 to 3 is manufactured are described below in the following Table 1.

TABLE 1

| Parameters | Applied value | Min | Max |
|---|---|---|---|
| Diameter of the | 1 μm or 540 nm | 0.01 μm | 10 μm |
| silica particles | | | |
| Solvent | Butanol | | |
| Concentration | 35 g/l | 10 g/l | 50 g/l |
| Carrier liquid | Deionized water | | |
| Flow rate of the | 400 ml/min | 100 ml/min | 1000 ml/min |
| carrier liquid | | | |
| Injection flow rate | 0.5 ml/min | 0.01 l/min | 3 ml/min |
| of the particles | | | |
| Pull speed | 1 cm/min | 0.1 cm/min | 10 cm/min |

In FIGS. 4 and 5, the dry-etching process implemented in the fourth step 210 is for example a reactive-ion etch using a gaseous mixture of sulfur hexafluoride (SF₆) and dioxygen (O₂) in a ratio of 5/3. Other gases, able to selectively etch the material with respect to the beads, will possibly also be used.

Generally and independently of the dry-etching process used, the etch rate Vmat of the material of the substrate and the etch rate Vpar of the particles are higher than 50 nm per minute, and the etch selectivity Sg, which is defined as the ratio of the etch rate of the material of the substrate to the etch rate of the particles, is comprised between 0.5 and 10.

When a textured surface of FIGS. 1 to 3 is manufactured, the dry-etching process described below may be used. This etching process implements:
530 nm or 1 μm beads of silica SiO₂ deposited using a colloidal process with flotation of a compact monolayer of beads on a solvent and transfer to the substrate to be textured;
an RIE (reactive-ion etching) reactor;
a generator of 13.56 GHz frequency;
an SF₆ and O₂ gas mixture;
flow rates of 5 sccm SF₆ and 3 sccm O₂;
a pressure of 25 mTorr;
a power of 0.25 W/cm² (20 W over a platen of 10 cm diameter); and
a substrate temperature equal to 50° C.

The length of the etching process depends on the type of material used for the substrate and on the diameter used for the beads.

When beads of 530 nm diameter are used, the length of the etching process is equal to 600 seconds for a substrate material of the first type (SiC), and equal to 480 seconds for a substrate material of the second type (SiSiC).

In the case of silicon beads of 1 micron diameter, the length of the etching process is multiplied by 2 with respect to the beads of 530 nm diameter giving, for example, 1200 seconds for a substrate of the first type, i.e. a substrate of SiC.

The etching-process conditions defined above are conditions optimized to obtain selectivity (ratio of the etch rates of the silica-bead mask and the material to be etched i.e. the SiC or SiSiC) allowing, for the microstructures, an aspect ratio, defined as the ratio of their height to their width, of about 1, i.e. comprised between 0.3 and 5, to be obtained.

Other etch chemistries may be used, in particular fluorine-containing chemistries.

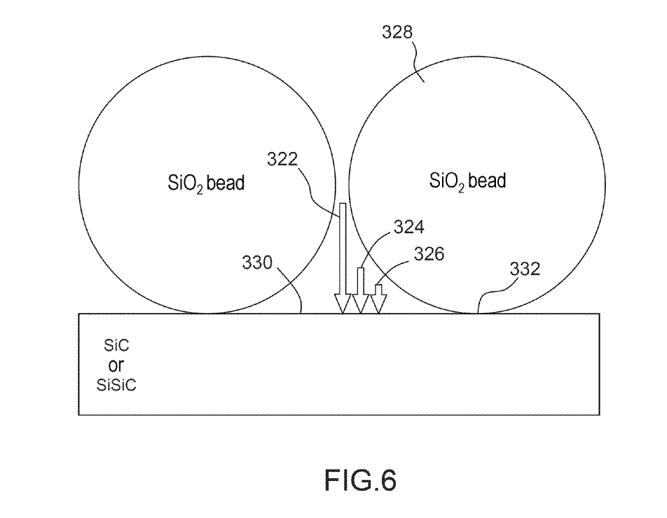

In FIG. 6, the dry-etching mechanism called “ion bombardment” is implemented in the manufacturing processes of FIGS. 4 and 5.

Via this mechanism, which is represented by the arrows 322, 324 and 326, ions issued from the SF₆ plasma anisotropically attack the surface of the substrate head-on and with a low selectivity, the surface of the substrate being accessible through gaps between the masking beads. The easier the access to the surface of the material through the carpet of beads, the greater the effectiveness of the attack. In FIG. 6, the lengths of the attack arrows 322, 324 and 326, which are proportional to the intensity and effectiveness of the plasma attack, decrease starting from a point 330 of the substrate surface that is under “open sky”, to a point of contact 332 with the masking bead 328. The etching by ion bombardment of the surface of the substrate is accompanied by etching of the mask by ionic erosion of the surface of the masking beads, the erosion of the surface of the masking beads having an effect on the etch rate. This mechanism, which is referred to as “ion bombardment”, is the origin of the shape of the microstructures described in FIGS. 1 to 3.

Thus, the process of FIGS. 4 and 5 allows structures such as those described in FIGS. 1 to 3 to be obtained.

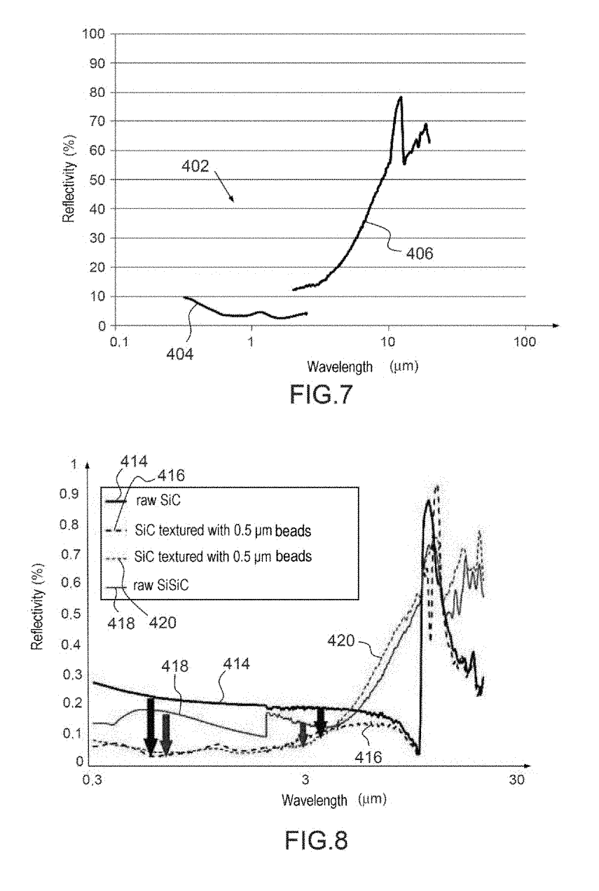

The reflectivity spectra obtained for the selective antireflection optical surfaces in particular described in FIGS. 1 to 3 are analogous to the spectrum 402 illustrated in FIG. 7, which was measured for a structure formed in an SiSiC material. The reflectivity, measured in the domain of the visible and near infrared, i.e. for wavelengths comprised between 0.3 and 2.5 microns, is greatly decreased, this therefore allowing an effective solar absorber to be produced.

The spectral measurements were carried out on the same sample of textured surface made of SiSiC using a first measuring apparatus that delivered a first spectral curve 404 in the visible domain, and using a second measuring apparatus that delivered a second spectral curve 406 in the infrared domain.

In FIG. 7, the reflectivity spectra 404, 406 in the visible and infrared domains exhibit a reflectivity difference, a low reflectivity or high absorption for a thick non-transparent medium being observed in the visible domain, and a relatively high reflectivity, or low emissivity according to Kirchhoff's law, being observed in the infrared (IR) domain. Here, a solar absorption of 95.9% and an emissivity at 500° C. of 67% are measured.

In FIG. 8, the reflectivity spectra of the optical surfaces using the materials SiC and SiSiC before and after the formation of structures are gathered.

A first spectrum 414 illustrates the variation in reflectivity, expressed in percentage on a linear scale, as a function of wavelength, expressed in microns on a logarithmic scale, for a smooth or non-textured raw optical surface made of silicon carbide.

A second spectrum 416 illustrates the variation in reflectivity as a function of wavelength for an SiC antireflection optical surface made of silicon carbide, the SiC antireflection optical surface being textured with a mask of self-organized beads of 0.5-micron (μm) diameter.

A third spectrum 418 illustrates the variation in reflectivity as a function of wavelength for a smooth or non-textured raw optical surface made of silicon carbide enriched with silicon (SiSiC).

A fourth spectrum 420 illustrates the variation in reflectivity as a function of wavelength for an SiSiC antireflection optical surface made of silicon carbide enriched in silicon, the SiSiC antireflection optical surface being textured with a mask of self-organized beads of 0.5-micron (μm) diameter.

The large decrease in reflectivity and therefore the improvement in the absorption in the domain of the visible and of the near infrared for the two types of silicon-carbide-based materials (SiC, SiSiC) may be seen by comparing the second and fourth spectra 416, 420 with the first and third spectra 414, 418.

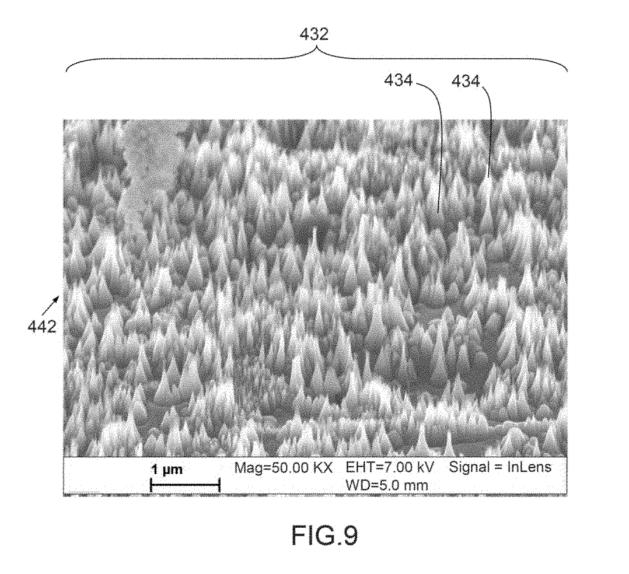

It will be noted that the manufacturing process according to the invention, which uses a dry etch, generates a special technical effect when the use of a bead mask is omitted during the etching step. Specifically, as shown in FIG. 9, without the bead mask parasitic micro-masking of small dimensions appears on the silicon-carbide-based optical surface because of the deposition of carbon, this micro-masking being related to the deposition of carbon-containing molecules issued from the etching gas and of subproducts of the etching reaction. The effect of this micro-masking is to create a carpet 432 of parasitic microstructures 434 that take the form of needles of at most about one-hundred nanometre width on the optical surface 442 thus obtained.

In contrast, in the case where silicon is present, used in the self-organized beads of the mask provided in the manufacturing process according to the invention, oxygen present in the composition of the beads is released during the etching and modifies the composition of the reaction products, preventing the accumulation of carbon on the surface of the substrate and thus avoiding the parasitic micro-masking. The hexagonal close-packed structure of smooth domes, which will exhibit a good resistance to oxidation, is then achieved.

The structures of the antireflection optical surfaces such as described in FIGS. 1 to 3 or obtained by the manufacturing processes described in FIGS. 4 to 6 are very highly suitable for solar absorbers and have the two-fold advantage of a very good capacity to absorb solar radiation and an excellent resistance to oxidation in air or any other oxidizing medium.

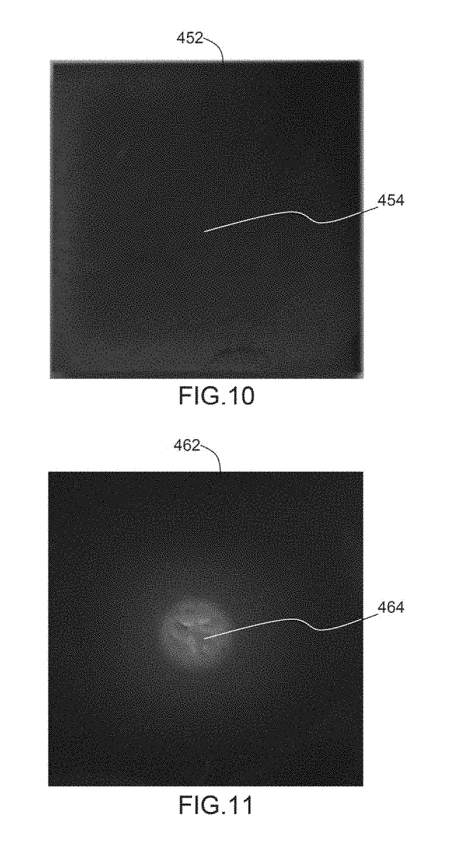

In FIG. 10, an optical view of a sample 452 of an enriched-silicon-carbide (SiSiC) antireflection surface according to the second embodiment of FIG. 3, obtained after 745 W/m² of solar illumination concentrated with a concentration factor of 1000 into a concentration spot 454 of 10 mm diameter and a temperature increase in this spot to 676° C., shows that the structure of the surface produced in the silicon carbide enriched in silicon (SiSiC) exhibits no deterioration after exposure under high solar concentration in air to almost 700° C. The concentration spot cannot be distinguished in this view from the rest of the surface of the sample.

In contrast, in FIG. 11, an optical view, analogous to that of FIG. 10, of a sample 462 of a molybdenum (Mo) surface nanostructured according to the process of the aforementioned patent application WO 2015/114519 A1, and obtained after 810 W/m² of solar illumination concentrated with a concentration factor of 1000 into a concentration spot 464 of 10 mm diameter and the attainment of a temperature in this spot of 582° C., shows that the surface of the nanostructured molybdenum material oxidizes in the concentration spot 464, which is distinguishable in FIG. 11 by its lighter hue, and exhibits very substantial deterioration in air.

The structure of the antireflection optical surface 452 according to the second embodiment of FIG. 3 has a better resistance to oxidation than that of the nanostructured molybdenum 462 of FIG. 11, which cracked and delaminated under the effect of its oxidation in air.

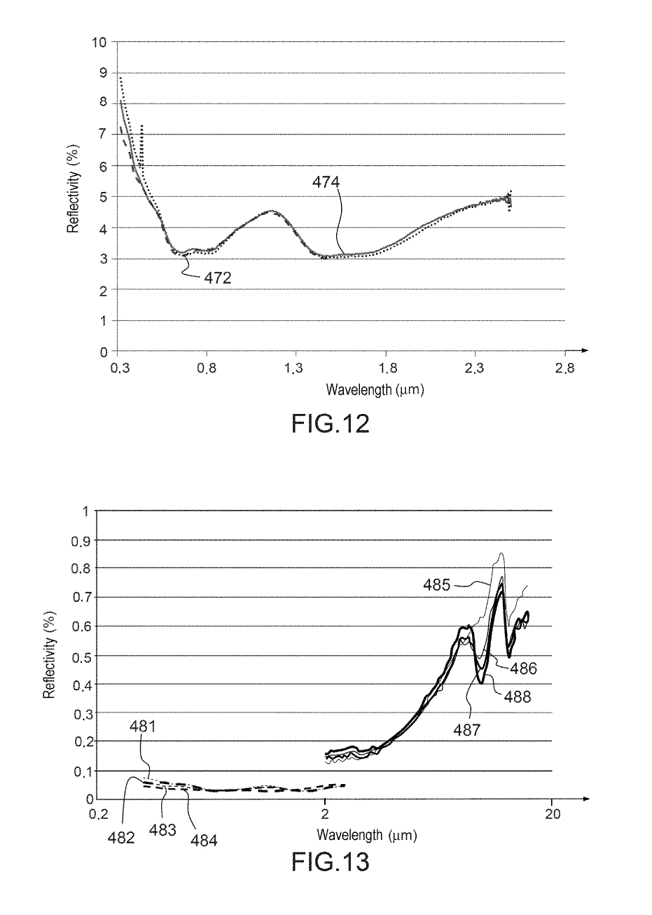

In FIG. 12, a first spectrum 472 and a second spectrum 474 of the reflectivity of an absorber made of enriched silicon carbide (SiSiC) the surface of which is structured according to the second embodiment of FIG. 3 are illustrated. The first and second spectra 472, 474 are the spectra measured before and after exposure to incident solar radiation of 900 W/m² of solar radiation concentrated by a Fresnel lens of 1000× magnification and of 33×33 cm² size, respectively.

The first and second spectra 472, 474 confirm the very good resistance to oxidation of absorbers structured according to the invention, the two reflectivity spectra before and after solar exposure being superposable.

In FIG. 13, reflectivity spectra, 481, 482, 483, 484, 485, 486, 487, 488, measured in the domains of the visible and of the infrared, of an absorber made of enriched silicon carbide (SiCSi) the surface of which is structured according to the second embodiment of FIG. 3, are illustrated. The spectra 481, 482, 483, 484 in the domain of the visible and the spectra 485, 486, 487, 488 are respectively measured at various respective times, 0 hours, 3 hours, 15 hours and 25 hours, during ageing in air at a temperature of 1000° C.

FIG. 13 confirms the integrity of absorbers structured according to the invention for extremely high ageing temperatures of about 1000° C., in air, with the spectra in the visible domain 481, 482, 483, 484 and in the infrared domain 485, 486, 487, 488 remaining unchanged between 0 and 25 hours.

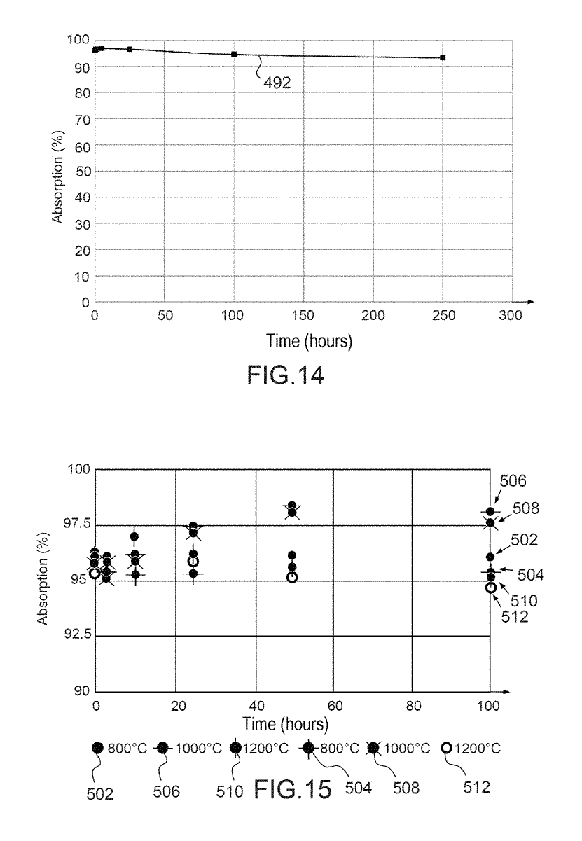

In FIG. 14, the variation 492 as a function of time of solar absorption measured for a solar absorber made of enriched silicon carbide (SiSiC) the exposure surface of which is structured according to the second embodiment of FIG. 3 is illustrated, the ageing taking place at a temperature of 1000° in air. It appears that the solar absorption and therefore the reflectivity parameter remains almost unchanged over time for extreme temperatures and confirms the excellent performance in terms of lifetime of absorbers structured according to the invention.

In FIG. 15, the variation 502 as a function of time of solar absorption measured for two samples of a solar absorber made of silicon carbide (SiC) the exposure surface of which is structured according to the first embodiment of FIG. 1, is illustrated, the two samples being exposed to air at three high temperatures equal to 800° C., 1000° C. and 1200° C.

A first set 504 and a second set 506 of measurement data respectively relate to the first and second samples for a temperature of 800° C.

A third set 508 and a fourth set 510 of measurement data relate to the first and second samples for a temperature of 1000° C.

A fifth set 512 and a sixth set 514 of measurement data relate to the first and second samples for a temperature of 1200° C.

The first, second, third, fourth, fifth and sixth datasets 504, 506, 508, 510, 512 and 514 confirm an excellent resistance to oxidation in air at high temperature of the solar absorber for the SiC material structured according to the invention, for example with paraboloidal or spherical caps of 0.5-micron or 1-micron diameter. Absorption performance is here maintained over time above 95%, independently of the extremely high temperatures considered here for the ageing.

These excellent lifetime properties are obtained by virtue of the intrinsic resistance of silicon carbide to oxidation but also by virtue of the special shapes of the structures produced according to the invention.

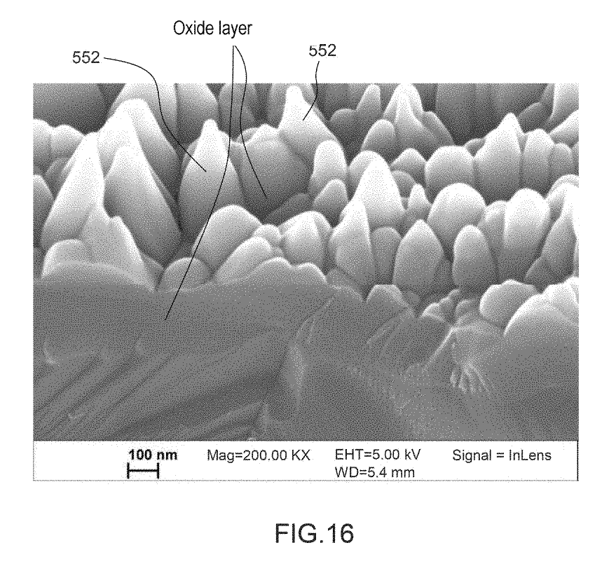

Specifically, as FIG. 16 shows, the irregular or uneven shape and the small size of parasitic microstructures 552, such as those of FIG. 9 and representative of the prior art, are clearly modified after 250 hours of ageing in air at an uninterrupted temperature of 1000° C. as they are completely oxidized with an oxide layer of relatively large size.

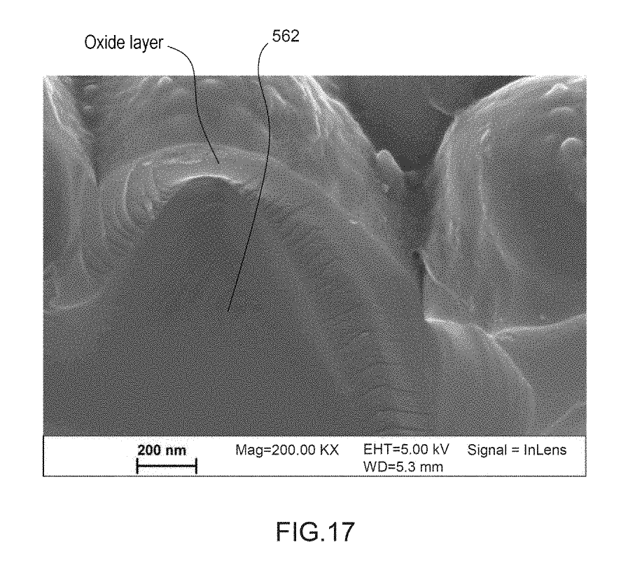

In contrast, as FIG. 17 shows, the regular (spherical, rounded-conical, parabolic) shape and relatively large size of the microstructures of a surface according to the invention of FIGS. 1 and 3, allow the microstructures 562 to preserve substantially the same shape and size while being only slightly oxidized superficially. Thus, the optical property of low reflectivity/high absorption is preserved under extreme temperature conditions and in an oxidizing medium.

Possible applications of the invention in particular relate to:
selective solar absorbers; and
systems comprising selective absorbers that are for example of planar or cylindrical shape.

1. An antireflection optical surface, exhibiting absorption in the domain of the visible and of the near infrared, in particular for thermal solar absorbers, said surface being able to operate at high temperatures, and comprising
a substrate, made of a thickness of a first material based on silicon carbide SiC, and having a curved or planar exposure face; and
a set of texturing microstructures carpeting the face;
said antireflection optical surface being characterized in that
each microstructure is formed by a single protuberance produced in the first material, said protuberance being placed on and integral with the substrate; and
the microstructures have the same shape and the same dimensions, and are distributed over the face of the substrate in a two-dimensional periodic pattern; and
the shape of each microstructure is smooth and regular as it has a single apex and a radius of curvature that varies continuously from the apex of the microstructure to the face of the substrate.

2. The antireflection optical surface according to claim 1, wherein the first material based on silicon carbide is
polycrystalline or single-crystal silicon carbide SiC; or
polycrystalline or single-crystal silicon carbide SiC, enriched with silicon in the form of islands of silicon Si.

3. The antireflection optical surface according to claim 1, wherein
the surface of each microstructure has the same given maximum in height h located in a central zone and corresponding to the height of the microstructure and lowers from the apex to an edge B of a base of the microstructure.

4. The antireflection optical surface according to claim 1, wherein
the surface of each microstructure includes a portion of the surface of a parabolic, elliptical or spherical cap.

5. The antireflection optical surface according to claim 1, wherein
each microstructure has substantially the same given base diameter d larger than or equal to 0.3 μm and smaller than or equal to 5 μm and preferably comprised between 0.5 μm and 2 μm; and
the same given maximum height h of each microstructure is larger than or equal to 0.5 times the base diameter d and smaller than or equal to 1.5 times the base diameter d.

6. The antireflection optical surface according to claim 1, wherein
the radius of curvature of each microstructure is larger than or equal to 0.1 μm and distributed about a central radius-of-curvature value comprised between 0.25 μm and 1 μm.

7. The antireflection optical surface according to claim 1, wherein
the arrangement of the microstructures on the exposure face of the substrate takes the form of a tiling of elementary microstructure networks,
the elementary networks having the same unit-cell shape selected from the group consisting of hexagonal unit cells, square unit cells, and triangular unit cells, and being characterized by a packing density of the microstructures with respect to one another.

8. A solar absorber including an antireflection optical surface defined according to claim 1.

9. A process for manufacturing an antireflection optical surface, in particular for thermal solar absorbers, said surface being able to operate at high temperatures,
said manufacturing process comprising
a first step consisting in providing a substrate, made of a thickness of a first material based on silicon carbide SiC, and having a planar or curved exposure face;
further comprising
a second step, executed following the first step, consisting in producing an array of texturing microstructures, carpeting the face,
each microstructure being formed by a single protuberance produced in the first material, and placed on and integral with the substrate, and
the microstructures having the same shape and the same dimensions and being distributed over the face of the substrate in a two-dimensional periodic pattern, and
the shape of each microstructure being smooth and regular as it has a single apex and a radius of curvature that varies continuously from the apex to the face.

10. The process for manufacturing an antireflection surface according to claim 9, wherein
the first step consists:
either in providing polycrystalline or single-crystal silicon carbide SiC, or
in providing polycrystalline or single-crystal silicon carbide SiC, enriched in silicon in the form of islands of silicon Si.

11. The process for manufacturing an antireflection surface according to claim 9, wherein
the first step consists:
either in isostatically compressing a powder of silicon carbide SiC, or
in making polycrystalline silicon carbide SiC grow, or
in making single-crystal silicon carbide SiC grow, or
in infiltrating silicon at high temperature into a porous carbon-containing matrix.

12. The process for manufacturing an antireflection surface according to claim 9, wherein
the second step comprises the following steps consisting in
in a third step depositing a compact monolayer of particles made of a second material on the surface of the substrate; and
in a fourth step etching, with a dry-etching process, the substrate on the side of the exposure face through gaps between the particles,
the second material being selected from the group consisting of silica (SiO₂) and polystyrene (PS), or any other material in the form of beads of required size.

13. The process for manufacturing an antireflection surface according to claim 12, wherein
the shape and size of the particles are decreased by dry etching,
either in a fifth step executed during the fourth step at the same time as the dry etching of the substrate,
or in a sixth step interposed between the third step and the fourth step.

14. The process for manufacturing an antireflection surface according to claim 12, wherein
the compact film of particles employed in the third step is deposited
either with a deposition technique employing a liquid/air interface to order the particles, which technique is selected from the group consisting of the Langmuir-Blodgett technique, the Langmuir-Schaefer technique, the surface-vortex method, the float-transfer technique, and the mobile-dynamic-thin-laminar-flow technique,
or with a deposition technique exclusively involving particles in colloidal solution, which technique is selected from the group consisting of electrophoretic deposition, horizontal deposition by evaporation of a film, deposition by evaporation of a bath, deposition by vertical removal of a submerged substrate and horizontal deposition by forced removal of a contact line.

15. The process for manufacturing an antireflection surface according to claim 12, wherein
the dry-etching process implemented in the fourth step is a reactive-ion etch using a gaseous mixture of sulfur hexafluoride (SF₆) and dioxygen (O₂) in a ratio of 5/3.

16. The process for manufacturing an antireflection surface according to claim 15, wherein
the etch rate Vsub of the substrate material and the etch rate Vpar of the particles; the etch selectivity Sg, which is defined as the ratio of the etch rate of the substrate to the etch rate of the particles; and the etching time are adjusted so as to consume the particles in their entirety and prevent the creation of sharp edges on the surface of the substrate.

17. The process for manufacturing an antireflection surface according to claim 12, comprising a seventh step of removing the particles, which step is executed after the fourth step.
